(19) United States
(12) Patent Application Publication
(10) Pub. No.: US 2005/0159999 A1
(43) Pub. Date: Jul. 21, 2005

(54) Method and system for developing a relationship between college students, universities and businesses

(76) Inventors: Gregory S. Totten, Amelia, OH (US); Christopher H Faraji, Amelia, OH (US)

Correspondence Address: WOOD, HERRON & EVANS, LLP, 2700 CAREW TOWER, 441 VINE STREET, CINCINNATI, OH, 45202, US

(21) Appl. No.: 10/739,718

(22) Filed: Dec. 18, 2003

(51) Int. Cl. G06F 17/60

(52) U.S. Cl. 705/14

(57) ABSTRACT

An information provider partners with an education institution, such as a university, and businesses to collect content that is of interest to the students at the educational institution. The information provider organizes and presents the content in an entertaining and dynamic way to attract the students to access the content. The university plays a role in establishing ways to access the content so that students are more likely to view the content as sanctioned by the university. The content is separated into a gateway, or portal, application with static content and the dynamic content. The portal application and static content are distributed by the university. The dynamic content is maintained by the information provider such that up-to-date information is made available to the student when the student accesses the content using the portal application.

### FIELD OF THE INVENTION

The present invention relates to presenting information to students at educational institutions but, more particularly, to a dynamic and computer-based presentation of such information.

### BACKGROUND OF THE INVENTION

When students initially go to college, they not only experience academic challenges, they also must handle a new range of freedoms and responsibilities. Often, the student is not only in a new adult atmosphere but they are in a different geographic location. The familiar stores, products, and responsibilities are replaced by new and different choices. Campuses typically provide student-life guides for freshman during early orientation meetings. These guides usually have important telephone numbers, semester calendars and other information about living on campus. Other organizations on campus also provide other information to students about the residence halls, the recreation facilities, intramural sports, alcohol awareness programs, etc. As a result, the student is presented a wide range of information from an array of different sources that can sometimes be confusing or even contradictory and easily becomes outdated. There is an unmet need at campuses today for a central source for academic and social information that is easily accessible, interesting, entertaining, easily updateable, and interactive.

From the university's perspective, they want to provide their students with an enjoyable experience during college so as to maximize retention and to build legions of loyal alumni. Thus, the university has an interest in ensuring that students have the information available to them that will allow them to feel more comfortable and confident about college. While the university can easily provide the academic-related information that a student needs, the university is not as well positioned to provide information about other topics such as, for example, banking and travel. As a result, the university has the need to form a partnership with an entity that will allow a broader range of information to be available to the students.

The traditional college-age market is one segment that is highly attractive to many businesses because the students are forming buying patterns and establishing brand loyalties that will likely extend far into the future. While these businesses have traditional advertising media available to them to reach the students, the businesses have difficulty in determining if the media are reaching the students and how effective the media is when it is received. Thus, such businesses have a need for an advertising media that will have a high likelihood of being seen by students and also provides feedback as to its effectiveness.

### SUMMARY OF THE INVENTION

Accordingly, embodiments of the present invention provide a method for building a relationship between businesses, universities and students that benefit all parties. One aspect of the present invention relates to a method for distributing a gateway application to multimedia information directed to a student at an educational institution. In accordance with this method, for example, the educational institution distributes the gateway application to newly matriculated students. In addition, within the multimedia information respective coupons are arranged from a plurality of businesses and one or more informational aids for the student are arranged as well. The gateway application includes a graphical user interface to permit the student to selectively access the multimedia information.

Another aspect of the present invention relates to a method for providing information to a student at an educational institution. In accordance with this aspect, first informational content is received from the educational institution and second informational content is received from a number of businesses. The first and second informational contents are then arranged into an interactive, multimedia source of information; and the student is provided access to the interactive, multimedia source of information.

Yet another aspect of the present invention relates to a method of providing content from multimedia information to a student using a gateway application distributed by an educational institution to newly matriculated students. In accordance with this method, a request is received for the content from the gateway application and the content is selected from among first informational content received from the educational institution and respective second informational content received from a plurality of businesses. The selected content is then transmitted to the gateway application.

Still another aspect of the present invention relates to a system for providing information to a student at an educational institution. In accordance with this aspect, the system includes one memory storing informational content from the educational institution and another memory storing respective informational content from a plurality of businesses. The system also includes a programmable computer that is connected with the two memories and that is configured to select interactive, multimedia content from the informational content, and provide the interactive, multimedia content to a gateway application distributed by an educational institution to newly matriculated students.

Additional advantages of the present invention will become readily apparent to those skilled in this art from the following detailed description, wherein only preferred embodiments of the invention is shown and described, simply by way of illustration of the best mode contemplated of carrying out the invention. As will be realized, the invention is capable of other and different embodiments, and its several details are capable of modifications in various obvious respects, all without departing from the invention. Accordingly, the drawings and description are to be regarded as illustrative in nature, and not as restrictive.

### BRIEF DESCRIPTION OF THE DRAWINGS

FIG. 1 illustrates a hardware platform on which computer readable media operates in accordance with embodiments of the present invention.

FIG. 2 illustrates a flowchart of an exemplary method for partnering with different entities to collect content for students at an educational institution.

FIG. 3 illustrates an exemplary interface screen in accordance with an embodiment of the present invention.

FIG. 4 illustrates a schematic view of a network architecture for implementing an embodiment of the present invention.

FIG. 5 illustrates a flowchart of an exemplary method of providing content to students at an educational institution.

FIGS. 6A-6C illustrate exemplary hierarchical organization models for content related to students at an educational institution.

FIGS. 7A-7F illustrate a series of exemplary interface screens for dynamically presenting content to a student at an educational institution.

FIGS. 8A and 8B illustrate a series of exemplary interface screens related to coupons in accordance with an embodiment of the present invention.

### DETAILED DESCRIPTION

The methods described herein for providing a central source of information for a college student are advantageously implemented as executable computer code that controls the operation of a microprocessor or computer during execution thereof. This code can be stored on a physical medium such as a disk or tape or can be transmitted signals that travel over various communications media. Before describing these methods in detail, an overview of a hardware platform supporting computer-readable media is provided.

Exemplary Hardware Platform for Computer-Readable Media

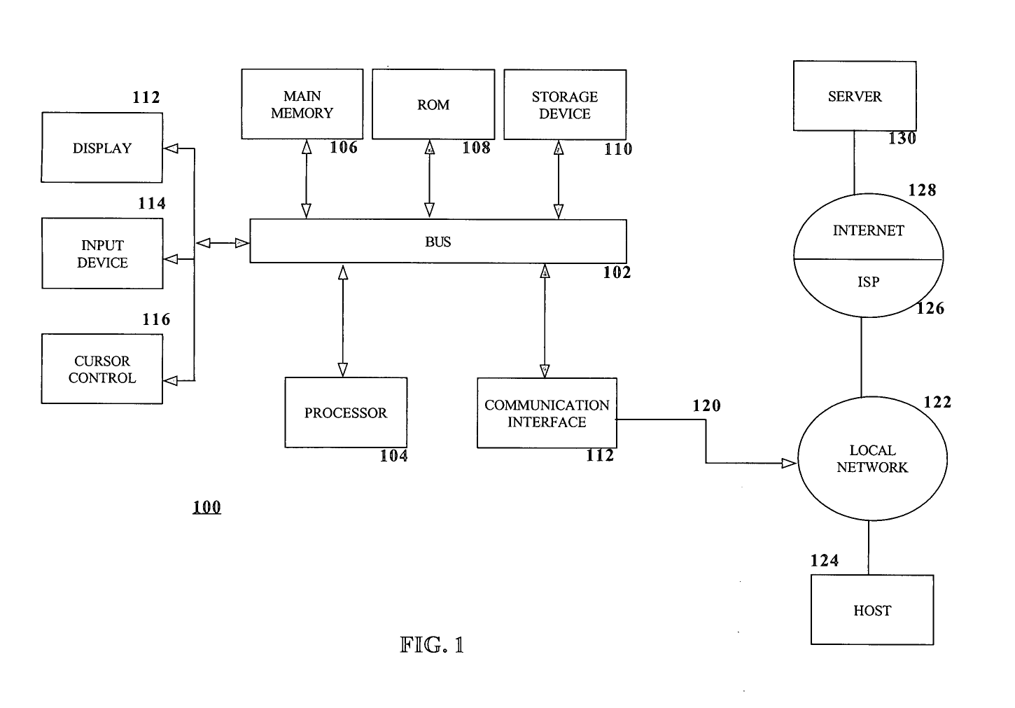

FIG. 1 provides a general description of a computer system that can execute such executable code as mentioned above and also interface with computer systems of partnering businesses, interested students, and a university in accordance with the principles of the present invention.

Computer system 100 includes a bus 102 or other communication mechanism for communicating information, and a processor 104 coupled with the bus 102 for processing information. Computer system 100 also includes a main memory 106, such as random access memory or other dynamic storage device, coupled to the bus 102 for storing information and instructions to be executed by the processor 104. Main memory 106 also may be used for storing temporary variables or other intermediate information during execution of instructions to be executed by the processor 104. Computer system 100 further includes a read only memory 108 or other static storage device coupled to the bus 102 for storing static information and instruction for the processor 104. A storage device 110, such as a magnetic or optical disk, is provided and coupled to the bus 102 for storing information and instructions.

Computer system 100 may be coupled via the bus 102 to a display 112 for displaying information to a computer user. An input device 114, such as a keyboard, including alphanumeric or other keys, is coupled to the bus 102 for communicating information and command selections to the processor 104. Another type of user input device is a cursor control 116, such as a mouse, a trackball, or cursor direction keys for communicating direction information and command selections to the processor 104 and for controlling cursor movement on the display 112.

The computer system 100 operates in response to processor 104 executing one or more sequences of one or more instructions contained in main memory 106. Such instructions may be read into main memory 106 from another computer-readable medium, such as storage device 110. Execution of the sequences of instructions contained in main memory 106 causes processor 104 to perform the process steps described herein. One or more processors in a multi-processing arrangement may also be employed to execute the sequences of instructions contained in main memory 106. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 104 for execution. Such a medium may take many forms, including but not limited to non-volatile media, volatile media, and transmission media. Non-volatile media include, for example, optical or magnetic disks, such as storage device 110. Volatile media include dynamic memory, such as main memory 106. Transmission media include coaxial cables, copper wire, and fiber optics, including the wires that comprise bus 102. Transmission media can also take the form of acoustic or light waves, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 104 for execution. For example, the instructions may initially be borne on a magnetic disk of a remote computer. The remote computer can load the instructions into its dynamic memory and send the instructions over a telephone line using a modem. A modem local to computer system 100 can receive the data on the telephone line and use an infrared transmitter to convert the data to an infrared signal. An infrared detector coupled to bus 102 can receive the data carried in the infrared signal and place the data on bus 102. Bus 102 carries the data to main memory 106, from which processor 104 retrieves and executes the instructions. The instructions received by main memory 106 may optionally be stored on storage device 110 either before or after execution by processor 104.

Computer system 100 also includes a communication interface 118 coupled to bus 102. Communication interface 118 provides a two-way data communication coupling to a network link 120 that is connected to a local network 122. For example, communication interface 118 may be an integrated services digital network (ISDN) card or a modem to provide a data communication connection to a corresponding type of telephone line. As another example, communication interface 118 may be a local area network (LAN) card to provide a data communication connection to a compatible LAN. Wireless links may also be implemented. In any such implementation, communication interface 118 sends and receives electrical, electromagnetic or optical signals that carry digital data streams representing various types of information.

Network link 120 typically provides data communication through one or more networks to other data devices. For example, network link 120 may provide a connection through local network 122 to a host computer 124 or to data equipment operated by an Internet Service Provider (ISP) 126. ISP 126 in turn provides data communication services through the worldwide packet data communication network, now commonly referred to as the “Internet” 128. Local network 122 and Internet 128 both use electrical, electromagnetic or optical signals that carry digital data streams. The signals through the various networks and the signals on network link 120 and through communication interface 118, which carry the digital data to and from computer system 100, are exemplary forms of carrier waves transporting the information. Computer system 100 can send messages and receive data, including program code, through the network(s), network link 120, and communication interface 118. In the Internet example, a server 130 might transmit a requested code for an application program through Internet 128, ISP 126, local network 122 and communication interface 118. In accordance with the invention, one such downloaded application provides for hosting distributed objects as described herein. The received code may be executed by processor 104 as it is received, and/or stored in storage device 110, or other non-volatile storage for later execution. In this manner, computer system 100 may obtain application code in the form of a carrier wave.

Business Entities and Relationships

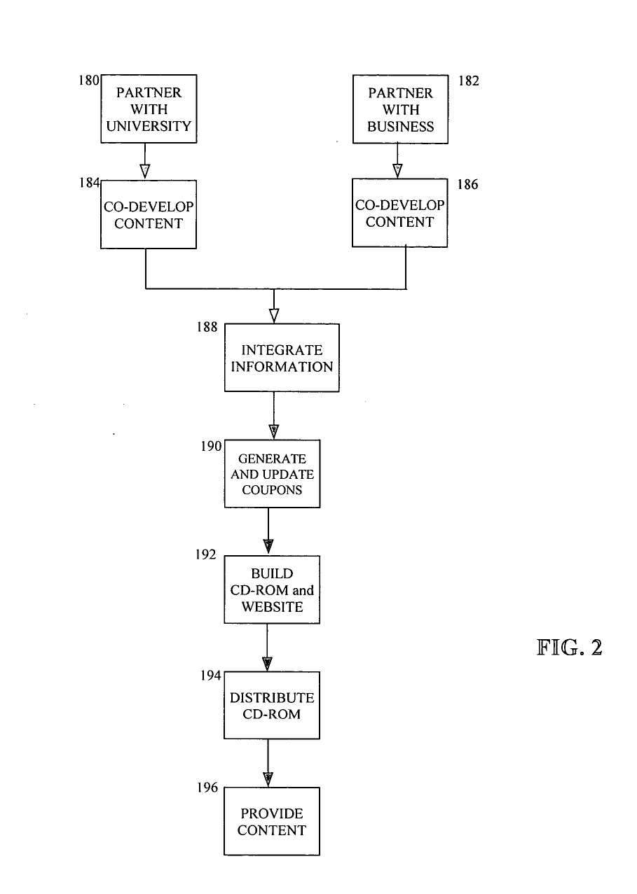

FIG. 2 depicts a flowchart of an exemplary method for developing an interactive and entertaining information source for students at an educational institution. In step 180, an information provider partners with a university. Together, the information provider and the university develop content, in step 184, that will be available for the students at the university. For example, the content can include information about dorm life and using the laundry machines in the dorms. The information can include information about campus life such as Greek organizations, other student activities, and paying for college. Other appropriate information, from the university's perspective, may include registration information, weather closings and advisories, and alcohol awareness programs or other health-related information. Some of this information may already be available online through the university's website and some of it may be included in pamphlets, booklets and telephone guides that are distributed by different university organizations. Thus, the content which the information provider and the university develop may include newly designed web pages but may also include link-throughs to existing content.

The information provider also partners, in step 182, with local, regional and national businesses. Advantageously, different levels of partnership can be offered to the businesses with the amount of exposure each business receives being related to the level, and the price, of the partnership chosen. For example, the highest level of partnership will allow the business, for example a bank, to provide fully interactive web pages that guide a student though the more common aspects of banking. For example, the student can learn about debit and credit cards offered by the bank, different checking accounts the student can open, and the student can even be allowed to sign up for a checking account online. A lower level partnership may limit the business's exposure to an address, a telephone number, and a link to a website. Intermediate levels of partnership can be provided that include such benefits as being linked to an interactive campus map so that students can easily locate a business on the map. Together, the information provider and each business develop, in step 186, content to be made available to the students that the business wants to present to the students.

The information provider then, in step 188, integrates the content into a central information source which the information provider maintains and controls access to. In particular, the content from the businesses and the university can include coupon information. This coupon information could either be an initial coupon placement or an update to an existing coupon. One advantageous technique for presenting coupons is to provide a coupon page that is easily updated (as discussed in more detail later). According to this technique, a business partner buys a coupon space on the coupon page for a period of time, such as one year. The coupon space may also have a variable size that raises or lowers the price of that particular coupon space. With the purchase of the coupon space, the business is permitted to change coupons on a regular basis, such as, for example every month. Thus, the initial content that the information provider and the business developed in step 186 may include the purchase of a coupon space and a graphic representation of the coupon that is displayed on the coupon page. Subsequent content development with that business may simply include an updated coupon graphic for display. Accordingly, in step 190, the information provider generates and/or updates coupon information to be available for the students. This coupon information is advantageously organized by business name, business type, or keywords so that the coupons can be indexed so as to be searchable. In addition to coupons being beneficial for businesses, the university can also include coupons to be used at the dining halls or other facilities on campus.

Next, the information provider builds, in step 192, the content and coupons into a website and an accompanying compact disk (CD-ROM). One alternative may be to put as much content as possible on the CD-ROM. While this alternative would allow a student to access a lot of information without being connected to the Internet, a new CD-ROM would need to be created and distributed to effect changes to content and coupons. A preferable alternative is to structure the CD-ROM as a gateway, or portal, to a website that contains most of the content. The content at the website is easily updateable while the CD-ROM provides the structure through which the student access the website.

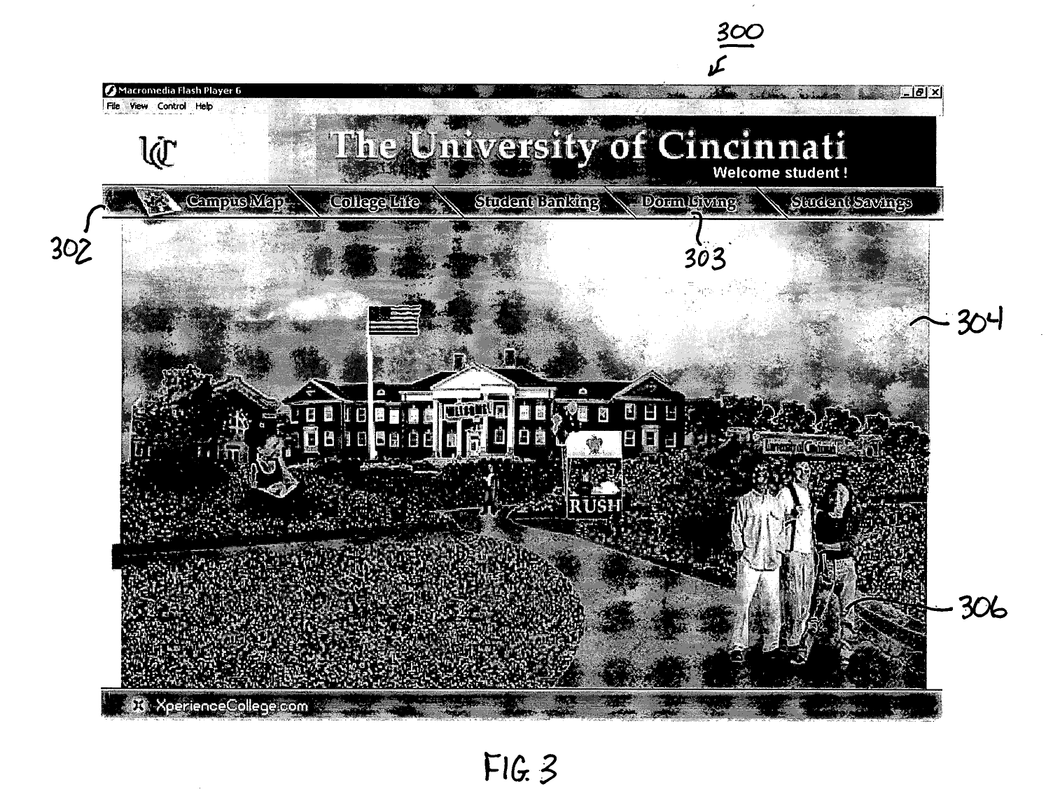

When the student executes the CD-ROM, a web browser application is activated that provides the user interface to the student. FIG. 3 illustrates an exemplary interface screen 300. The screen 300 includes a navigation bar 302 that has individual tabs 303 and a main window 304 that includes dynamic elements 306. For example, the screen 300 can be included on the CD-ROM as the welcome screen for a student. However, when the student selects a tab 303 or rolls-over a dynamic element 306, a link to the website is activated. Thus, in response to a selection by the student, the information provided comes from the website and not from the CD-ROM. The above described separation of content is only one example. For instance, the navigation bar 302 can be an empty graphical element on the interface screen 300 until the website is accessed. In accordance with this example, the student executes the CD-ROM and the resulting web browser application automatically accesses the website for initialization purposes. Part of the initialization process is for the website to inform the browser application that there are currently five items for display in the navigation bar 302, what the title is for each of these five items, and the location to where each of these items link. As a result, the web browser builds the navigation bar 302 dynamically based on the content at the website.

Once the website and CD-ROM are built, the CD-ROM's are ready for distribution, in step 194. While the CD-ROMs can be distributed a number of ways, such as at the bookstore, at the Student Union, and at local businesses and similar places, the CD-ROMs are advantageously distributed during freshman, or new-student, orientation as part of the official information provided to the students from the university. This method of distribution permits the university to highlight this source of information and help, ensures that each student receives a copy of the CD-ROM, and increases the likelihood that a student will access the CD-ROM. After distribution, the application on the CD-ROM is executed and the information provider responds by providing appropriate content, in step 196, from its website.

Exemplary Network and Website Arrangement

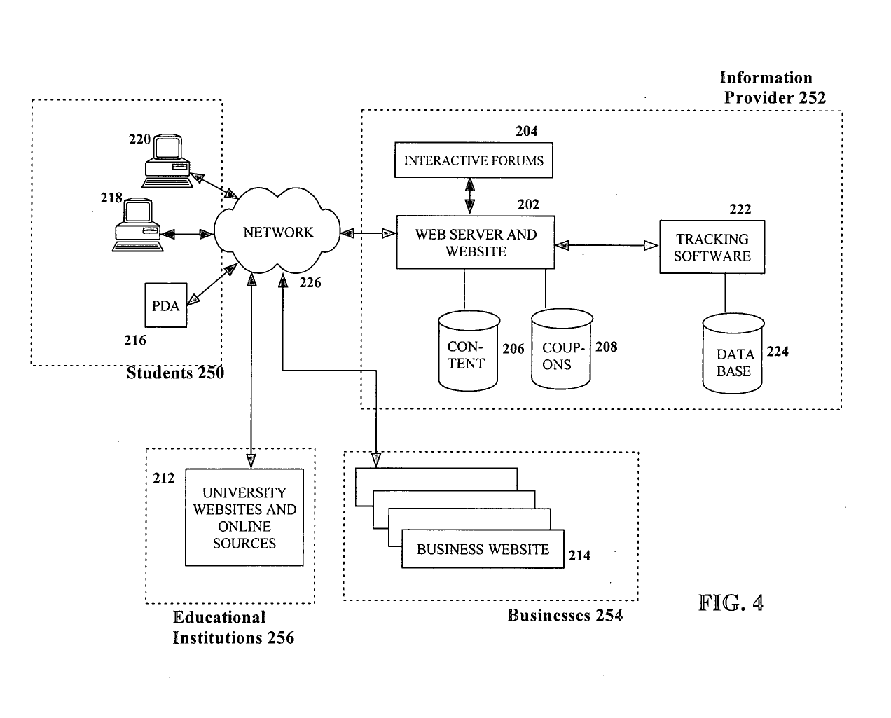

FIG. 4 depicts an exemplary network arrangement that provides a central source for information and answers to virtually every question a student may have about the academic and social aspects of college in a form that is easily accessible, interesting, entertaining, updateable and interactive. The figure also shows the four major partners involved in helping the students receive the information they need to feel more confident and comfortable at college. These partners include the students 250, the educational institution 256, businesses 254 interested in the student demographic, and the information provider 252 that is the central source of information for the students 250. The information provider 252 does not necessarily create all the content and information provided to the students 250; but, instead, may rely, and advantageously does rely, on the educational institution 256 and the businesses 254 for information.

At colleges today, students have a number of computer resources available to them. For example, a computer 218 may be in a residence hall community room or a computer lab at a library on campus. Also, a computer 220 may be a student's own computer through which they can access the internet 226 via a telephone line, a wireless connection, or a higher-speed network medium. Wireless telephones and personal digital assistants (PDAs) 216 have become additional methods for students to stay connected to the Internet 226. As previously mentioned when describing the flowchart of FIG. 2, the information provider 252 distributes, through the university 256, a CD-ROM that is executable on the student computers 218, 220. In addition to, or in place of, a CD-ROM, the same information may be distributed by memory sticks, mini hard-drives and other physical storage media.

In fact, the actual distribution of the CD-ROM, or other media, is not a necessity but, rather, advantageously ensures that a student receives access to and information about the information provider 252 from the university 256 during freshman, or new-student, orientation. By putting the same web pages and templates that are on the CD-ROM onto the website 202 itself, the student can use a generic web browser to access the same information as if he had used the CD-ROM interface. Thus, other less-traditional computing platforms, such as the PDA 216 may be used to access the information on the website 202 as well. In one alternative, the website 202 can automatically detect that the web browsing application of a PDA 216 is being used such that the website 202 will provide its content in a low bandwidth format.

As known to one of ordinary skill, the web server 202 is a hardware platform running a software application that provides a website on the Internet 226 by receiving requests from remote computers 216-220 and responding with appropriate content. The content is normally organized as a hierarchical arrangement of web pages each having various associated links and information. One common way of providing a website is to define each web page as a template and identifying its associated content. When the web server 202 accesses a page, the template is retrieved and the content dynamically generated so as to build the page on-the-fly. This arrangement simplifies management and updating of web pages (and ensures a uniform look to the different web pages on the site).

This content 206 can be stored in a variety of formats and on various physical media. Typically, the content is arranged on a hard disk in a manner that permits easily locating and retrieving desired information. Multiple hard disks can be utilized as well, some even being located remotely from the web server 202. Although the content 206 for the website 202 includes the graphical images of the coupons 208, FIG. 4 illustrates that the coupons 208 may be stored separately.

The educational institution 256 may, itself, have a number of websites 212 along with the businesses 254 having there own websites 214 as well. While these websites can be accessed directly by a student, the information provider's website 202 also links to these other websites 212, 214. Thus, the website 202 does not need to duplicate everything available to the student nor does the website have to update and maintain the information on these other websites 212, 214. Accordingly, the student continues to be provided as much information from a central source as possible while easing some of the burden on the information provider 252.

The web server and site 202 advantageously includes interactive forums or message boards 204. Typically, an administrator at the information provider 252, creates different board topics such as: carpooling and commuting, Greek life, intramural sports, minority relations, etc. Students access the message boards through the website 202 and are permitted to interactively communicate with other students that are online or read past messages and post replies. A number of commercial solutions for interactive message boards 204 having various features exist and can be incorporated with the website 202.

Various commercial solutions also exist for tracking a user of a website. Accordingly, the system of FIG. 4 includes such tracking software 222 that tracks a student's visit to the website 202 and stores this information in a database 224. Some statistics that are usually tracked include how many times a coupon was accessed, how many times was a coupon printed, how many times a web page was accessed, what was the originating source for each access, where did the student exit to, how long was a page displayed on the screen, etc. More advanced tracking can include identifying the student through a user name or other identifier. With this information, the tracked information can be correlated with demographic information in a student database. This tracking information is available for the businesses 254 to assist them in evaluating the effectiveness of their advertising and their coupons.

Operation of the CD-ROM and Website

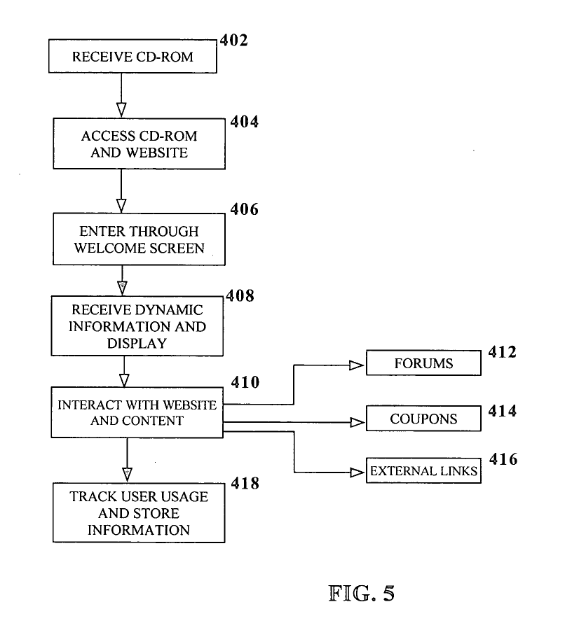

FIG. 5 illustrates an exemplary flowchart of the CD-ROM and the website 202 in operation. In step 402, the student receives the CD-ROM, or other storage media, at a new-student orientation program sponsored by the university 256. If a sophomore or other student desires a copy of the CD-ROM, then other distribution methods are used such as the registration office of the university or in the campus bookstore or student union. With the CD-ROM, the student executes a web browser application, in step 404, that accesses the website 202 of the information provider 252. The first screen the student encounters is a welcome screen in which the student, in step 406, enters a username and password. In addition to the username and password, the CD-ROM can also include a code or other identifier that is transmitted to the website 202 during login. This type of information permits the website 202 to track and monitor activity by either the student's name or by the CD-ROM identifier, or even by both.

In step 408, the student is provided through the website 202 with dynamic and interesting information in multimedia format. For example, music and animation are advantageously used to grab the attention of the student and to make the experience enjoyable. Graphics and other active displays are advantageously used to capture the student in an environment that they will like to return to. The first interface screen provides the student with selections about most aspects of college life. In response, the student interacts, in step 410, with the website 202 and its content. For example, in addition to academic related content, the student can chat, in step 412, on the message boards, access the coupon page, in step 414, to save money, and access external web links, in step 416, to receive more information than that solely provided by the website 202. During the interaction with the website 202 of step 410, tracking software 222 is being run, in step 418, to collect statistics about how the website 202 and its content 206 are accessed.

Content Organization

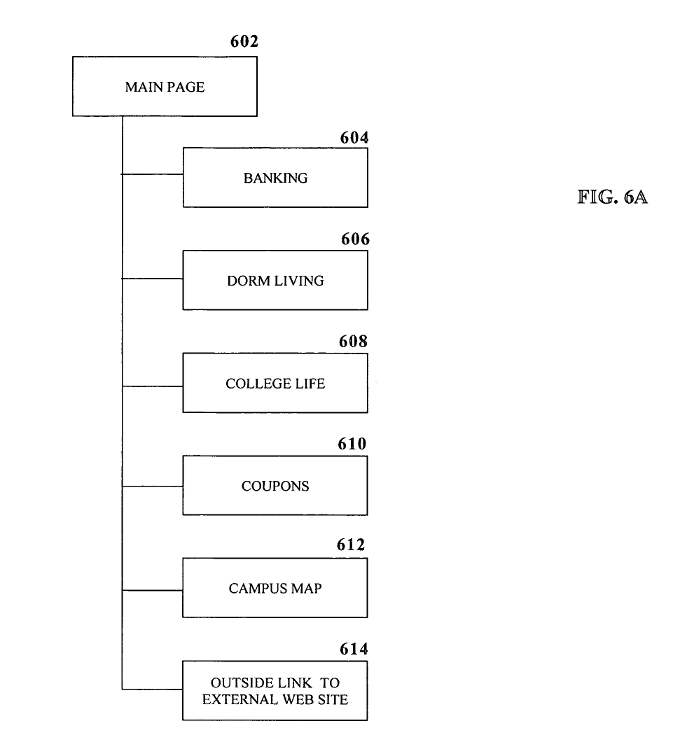

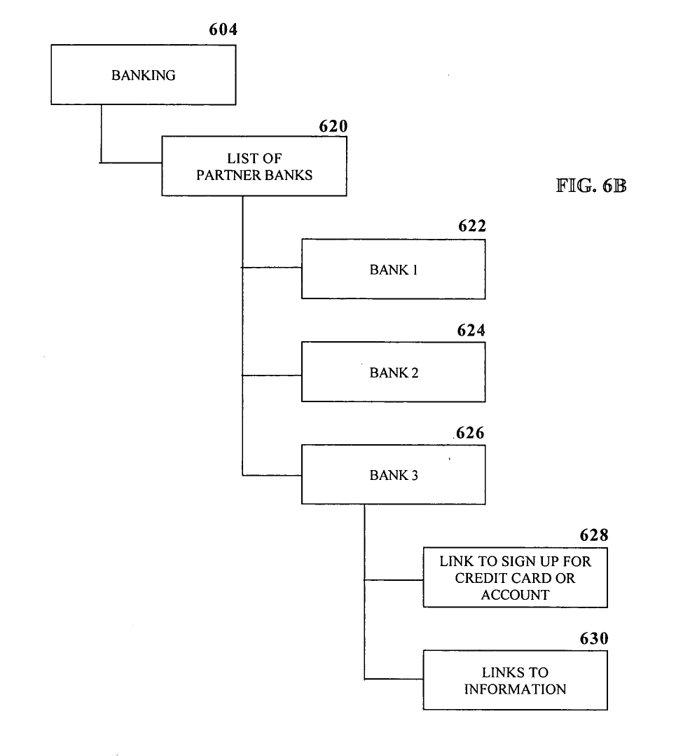

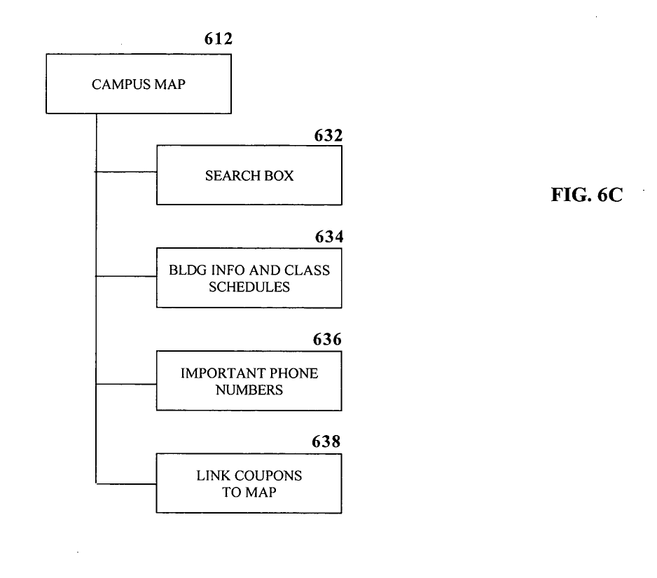

Embodiments of the present invention provide a central source of information for students at an educational institution such as a university. This information can cover a wide variety of topics and provide as much, or as little, detail as desired. The exemplary information topics discussed already and that will be discussed with the next set of figures is meant to provide examples of what types of information a student would find helpful. However, these specific examples are not intended to limit what information is made available to a student. For example, travel information such as car rentals, airline information and booking sites, as well as travel agencies and spring-break information can be provided to a student as well as the other examples already mentioned. Similarly, in addition to dorm life, the website 202 can provide links to local apartment buildings and primers on landlord/tenant law prepared by the university's legal office. The following figures are also not intended to limit the organization, or presentation, of the available information. For example one general topic page may be “Businesses” and a series of sub-topic pages would include “Banks”, “Restaurants”, and “Travel”. Alternatively, each of these sub-topics could be on their own general topic page right underneath a main page rather than being collected under a “Businesses” page. Accordingly, FIGS. 6A-6C illustrate just one example, from among a plurality of equivalents, of information that is made available to a student and its organization for presentation.

FIG. 6A depicts a hierarchical arrangement of information that a student may encounter when accessing the website 202. From the main page 602, the student is provided with six different general topics of information. These include, for example, banking 604, dorm living 606, college life 608, coupons 610, campus map 612, and an outside link 614. By selecting one of these topics 604-614, the student can focus his search for information. Typically, selection of one of the topic 604-614 will result in display of a web page for that topic that includes a list of available sub-topics.

Each topic 604-614 may have multiple sub-topics as well as multiple levels of sub-topics. For example, when the student selects the banking page 604, the student is presented with a page 620 that lists a number of banks. The banks, and the other businesses described herein, may be local, region, or national businesses. From the list on the page 620, the student selects a bank to reveal another page 622-626 that provides even more information. As mentioned earlier, the content on the pages 622-626 is advantageously dependent on the level of partnership for which each bank pays. The higher the level of partnership, the more complete and dynamic the content that is provided in the pages 622-626. For example, “Bank 3” has a page 628 that provides further links to sign-up for bank products and a page 630 that includes information on various banking topics that a student may want to see.

One alternative to having multiple businesses under one topic, such as banking 604, is to offer exclusivity to a business. For example, instead of offering the student information about a number of different banks, one bank agrees to partner with the information provider 252 upon assurances that they will be the exclusive bank advertised on the banking page 620. While this alternative may benefit the bank and allow for more aggressive pricing from the viewpoint of the information provider, it also limits the choices and information made available to the student.

FIG. 6C, is another example of various content and depicts the types of content choices that might be provided through a campus map that can be zoomed in and out. The map includes a search box 632 for identifying locations on the map and the buildings on the map link to information 634 such as hours and classes that are scheduled for the building. The campus map also can include important telephone numbers 636 for the campus in general or for each building. Also, the coupon page and the campus map interact so that when a coupon is selected, the location of the business is located on the map.

Although not explicitly depicted in a separate figure and separately discussed, each of the topics on the main page 602 have similar pages and levels of sub-topics as described above. The banking topic 604 and the campus map topic 612 have been discussed merely as examples to illustrate and provide a flavor for the wide variety of topics and subtopics of information that are made available to students via the website 202.

Referring back to FIG. 6A, the main page 602 includes a link 614 to an external website. This website is also maintained by the information provider 252 to add incentives for students to access the CD-ROM and the website 202. For example, the external website will include links to national advertisers and promotions. The website may also include sweepstakes and other marketing ideas to attract students from a number of different educational institutions. Separate from the businesses and offers on the website 202, this external website will include merchandise and advertisements that are attractive to college students. This external website also may include different data collection opportunities for the information provider 252. As a result, more complete demographic information is obtained for the students accessing the website 202 (and accessing the external website).

In addition to providing a central source of information to the student, the information provider 252 also benefits by providing that information in a graphical and dynamic way. Through interaction with the content of the website 202, the student becomes a part of the experience of the website 202 and is more likely to view the experience as enjoyable and return time after time. Thus, the partnering businesses benefit and the university retention rate is likely improved.

Graphical User Interface

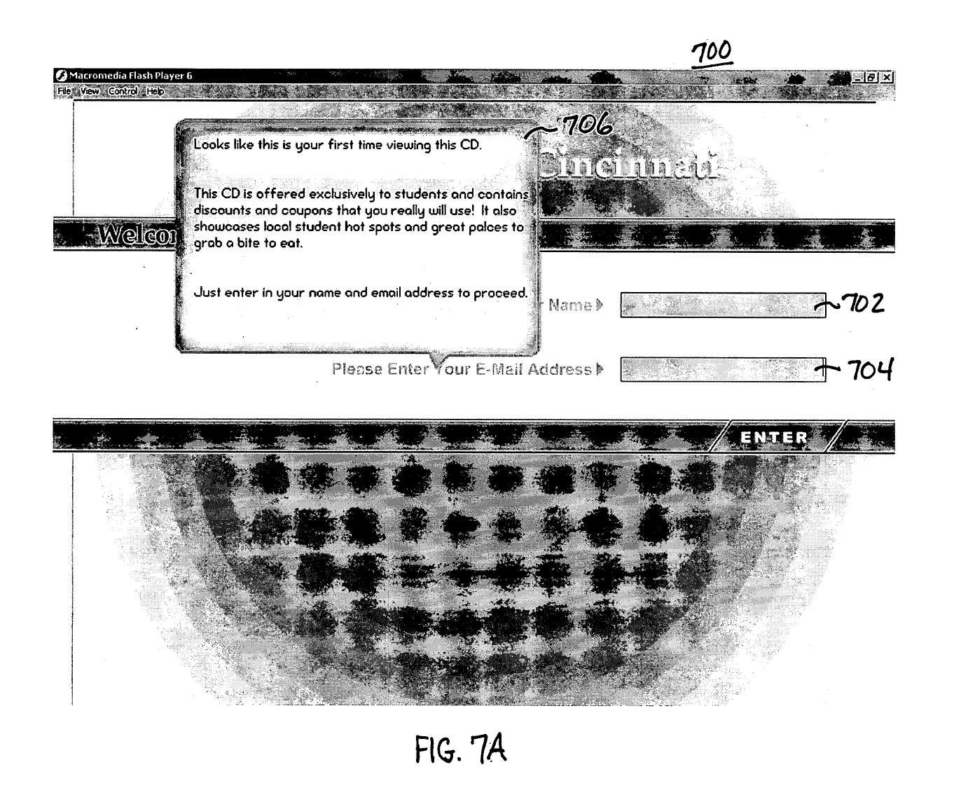

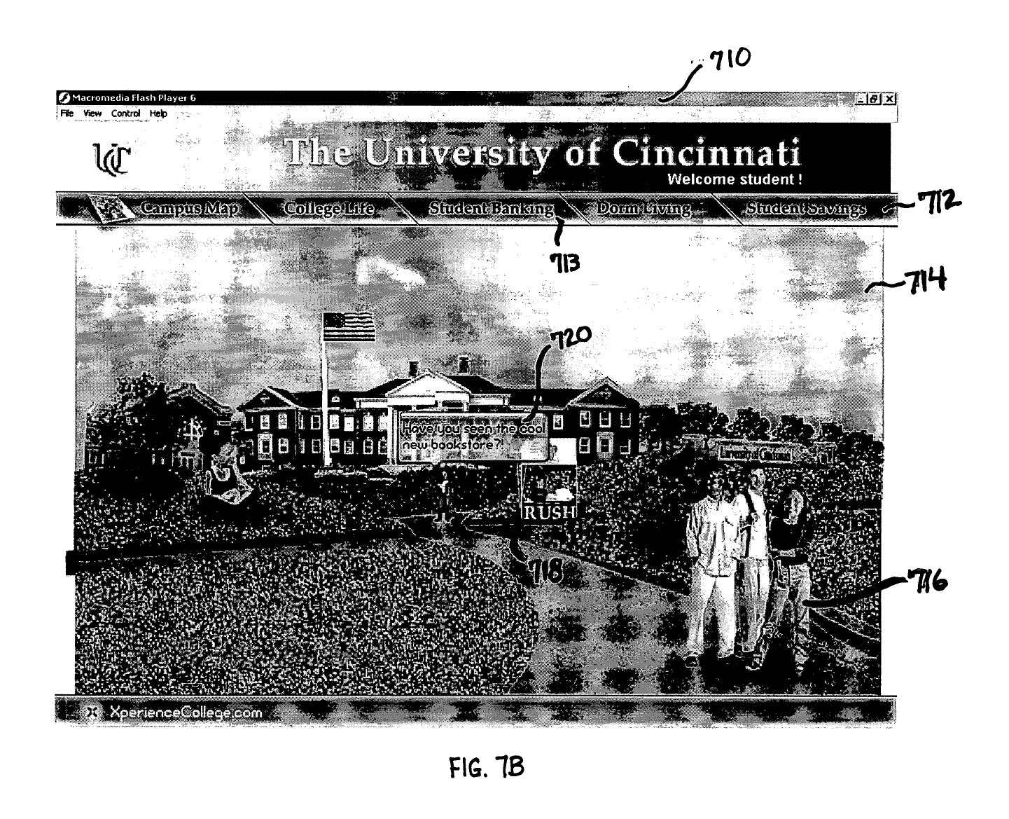

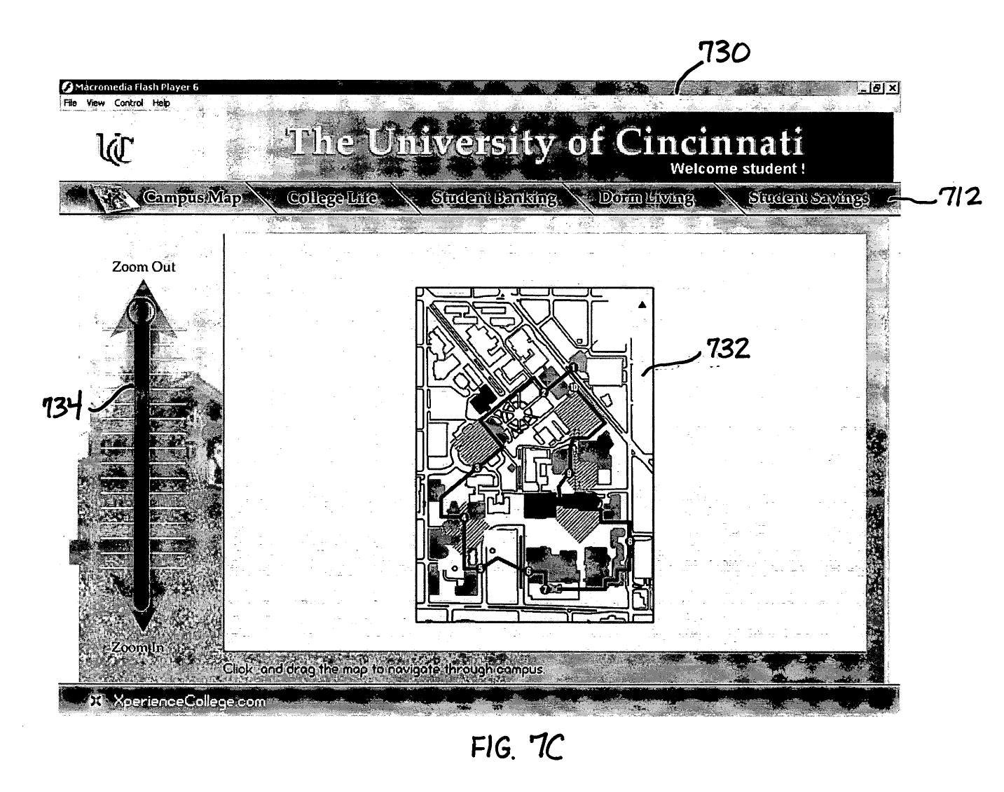

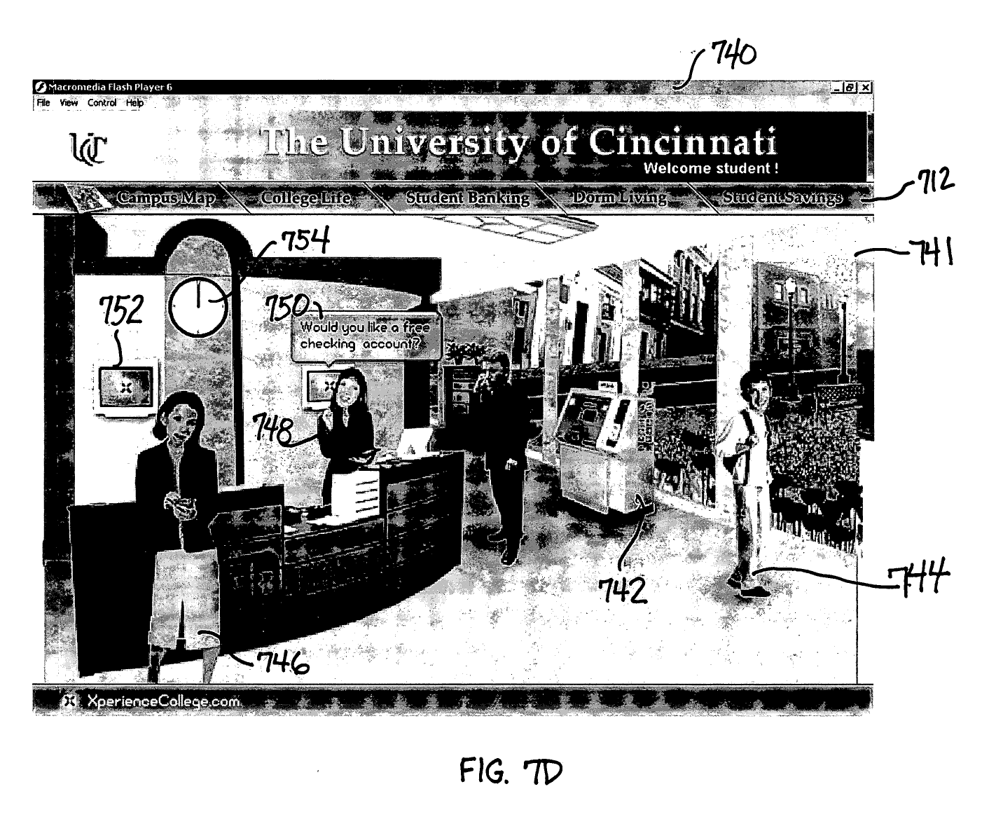

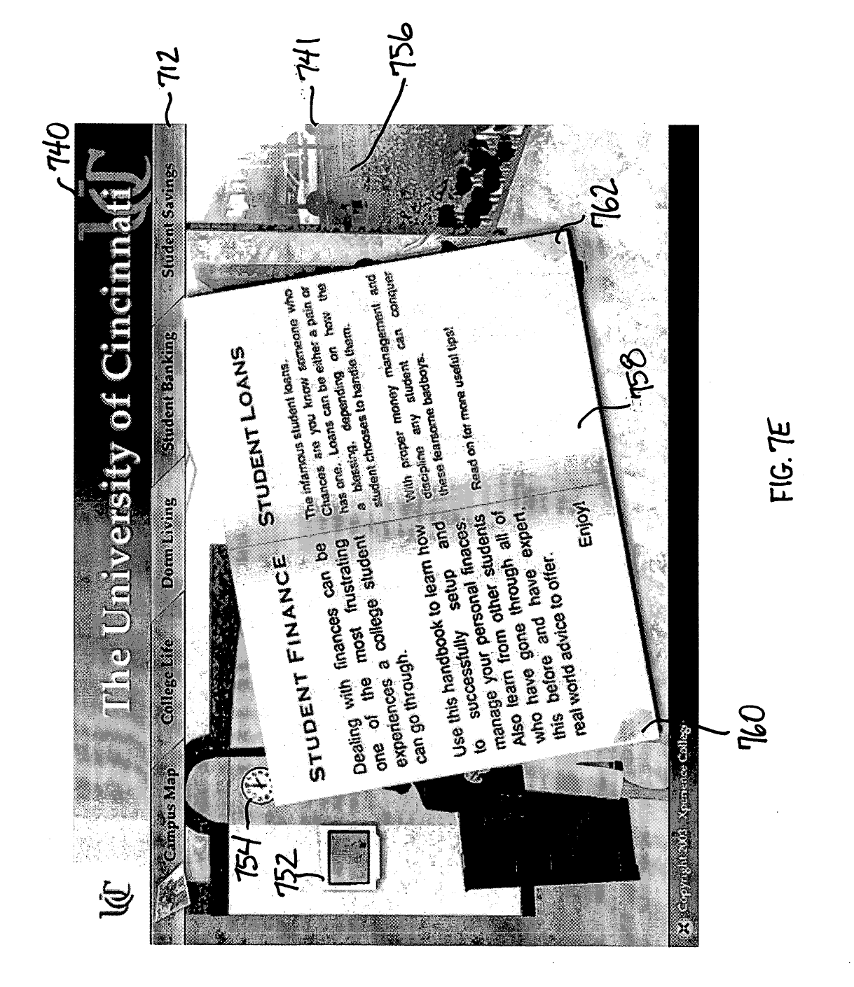

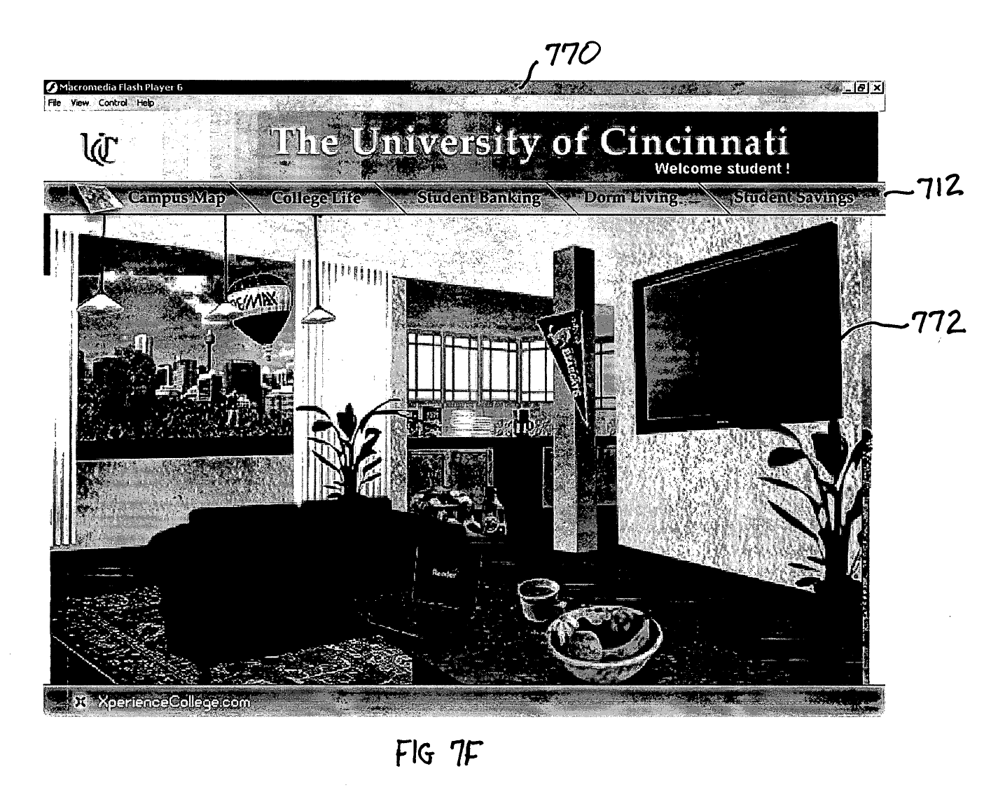

FIGS. 7A-7F illustrate exemplary graphical interface pages that provide a student with an enjoyable web experience. These pages will be displayed by the student's web browser application that can be from the CD-ROM or from a generic web browser. The interface screen 700 of FIG. 7A includes an input box 702 for a username and an input box 704 for an e-mail address. The student is also presented with an information screen 706 that explains that the input boxes 702, 704 must be filled-in to login to the website 202.

Once logged-in, the student is presented with a main screen such as, for example, the interface screen 710 of FIG. 7B. This screen 710 is similar to that described earlier in conjunction with FIGS. 2 and 3. The screen 710 includes a navigation bar 712 and main window 714. By selecting one of the tabs 713 of the navigation bar 712, the student is directed to an appropriate page for more detailed information. In addition to the navigation bar 712, the window 714 includes active elements 716, 718, 720 that, when a mouse roll-over occurs, provide pop-up information (e.g., 720) or links to other content. For example, the “RUSH” icon 718 links directly to information about fraternities and sororities on campus. Although not explicitly shown, animations such as a bird or airplane are contemplated that would fly across the window 714. These animations may include logo information and act as advertisements which the businesses have purchased. All these elements combine together to present the content in a interesting and entertaining way.

FIG. 7C illustrates a campus map page 730 that is presented when the student selects that tab from the navigation bar 712. The map page 730 includes a map 732 with zoom controls 734. As described earlier with respect to FIG. 6C, the map page 730 may include other options such as search capabilities and links from each building to detailed information about schedules and hours. The map may also be augmented with information about the partnering businesses. For example, when a student rolls a mouse over a business location on the map, a hyperlink can pop-up or additional information such as a logo or store hours will be displayed.

FIG. 7D illustrates a web page 740 for a partnering business that has interactive content. In this instance, the business is a bank and the web page 740 resembles a bank office. The business name is prominently displayed to provide initial graphical advertising information. Many of the elements in the main window 741 are dynamic or active elements. For example, when a mouse roll-over of the person 748 behind the counter occurs, the web page 740 displays a pop-up window 750. By clicking on that window 750, the student is able to perform the operation offered in the window 750. In this instance, the student is provided with information about opening a new checking account and preferably linked to the bank's own website where a secure account-opening procedure is conducted. The person 746 will include a pop-up window that greets you at the bank and offers you a list of options to select such, as for example, checking, credit cards, loans, mortgages, etc. From each of these options, a new web page will be presented that is appropriate for the selected option. For example, if “Mortgages” was selected, a page is displayed with the bank's current rates and terms.

The clock 754 is an active element that reflects the current time of the students computer and when clicked on might display the business hours of the bank. The ATM machine 742 and the student 744 are additionally active elements that provide other avenues for information about the bank and its products. One other active element is the display screen 752. This display screen 752 is used to provide detailed information about a topic to the student. This information can be about a specific product of the bank or be more general in nature. For example, by clicking on the display screen 752, the student is provided with a list of topics to learn about.

If for example, the student selected to learn more about student loans, the interface screen 740 of FIG. 7D would change to that of FIG. 7E. A graphic of a book 758 is displayed that provides detailed information about the topic of student loans. The book 758 include controls 760, 762 for flipping the pages of the book 758. The window 741 also includes an animated police car 756 that has entered the picture. This animation can be merely to entertain but may also include linking information such that if a student clicked on the car, contact information for the campus police would be displayed.

The interface page 770 of FIG. 7F is another illustration of an exemplary page that includes a number of active elements; these, in particular, are related to dorm life. For example, the television 772 can provide additional links to the local cable TV company or TV schedule information. By organizing and presenting the content in this manner, the information on the CD-ROM is that information which is relatively static such as the layout of the interface pages and the location of the active elements. However, the choices presented by each active element and the linked content to the active elements are stored as content 206 at the website 202. In this manner, the content 206 is easily maintained and updated so that the student receives the latest information without requiring a new CD-ROM. As different partnering businesses join, leave, or change their partnership level, the content provided to a student can be kept up-to-date.

One area in which the updateable content is beneficial is that of coupons. As a reminder, partnering businesses purchase subscriptions to a coupon space and provide a graphic image of the coupon for that space. Of course, the information provider 252 or other entity can generate the graphic image of the coupon as well. The subscription lasts, for example, for a year and permits twelve different coupon graphics to be changed once a month, for example, or according to some other schedule. Accordingly, the coupon page on the CD-ROM initially includes a screen 802 with no specific coupon information. When the CD-ROM accesses the website 202, however, a link in the coupon page retrieves from the website 202 a count of the available coupons and a link to each current coupon graphic image. From this information, the web page is dynamically built by the browser application of the CD-ROM to display the available coupons. Coupons can change frequently but, using this method, the coupons displayed for the student are those coupons that are currently available.

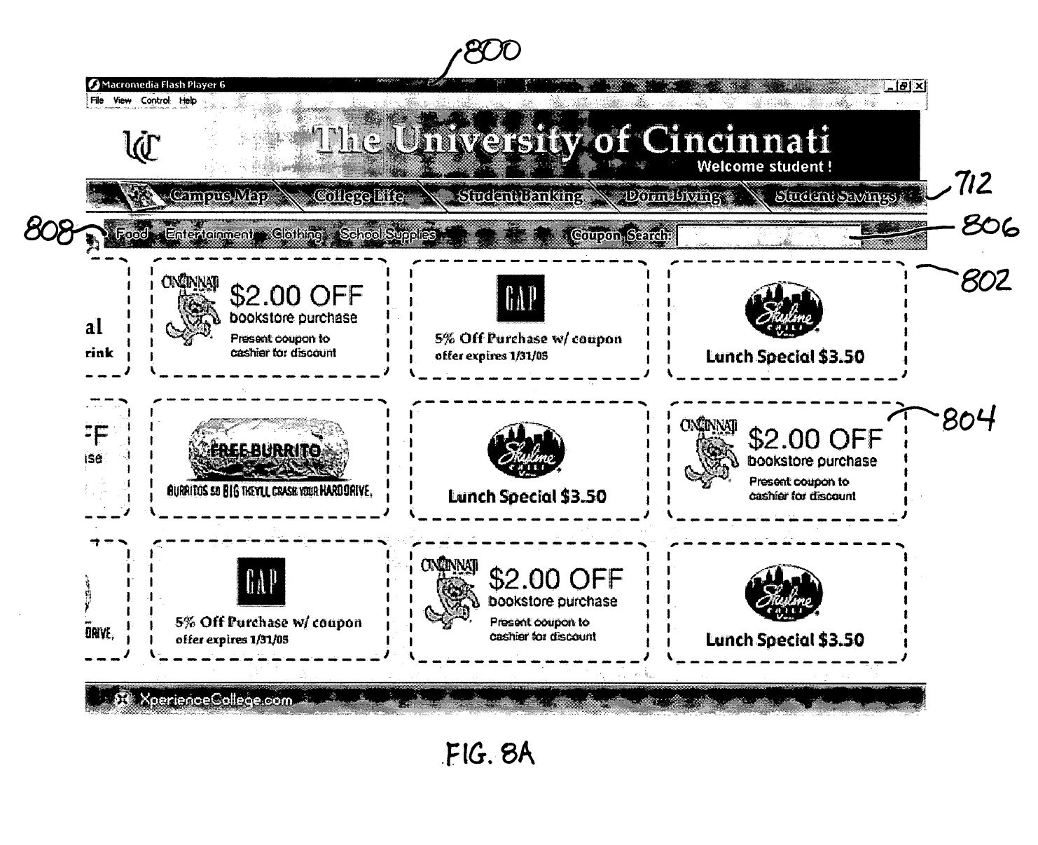

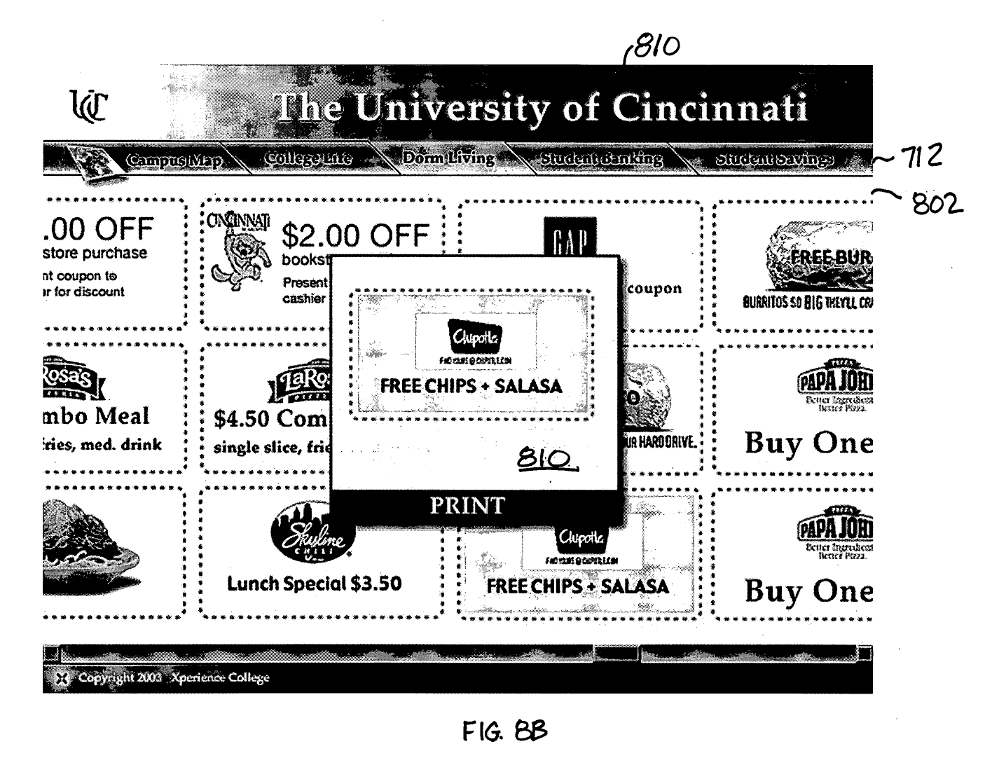

The coupon page 800 of FIG. 8A includes the navigation bar 712 and a main window 802. On this window 802 a number of individual coupons 804 are displayed for the student. To help the student locate a coupon, a search box 806 is advantageously provided and the coupons are categorized by selectable topics 808. The student selects a coupon 804 by clicking on it, resulting in a print window 810, as shown in FIG. 8B, that presents the coupon for printing. Once printed out the coupon is redeemed at the appropriate establishment. After the coupon is printed, the student can automatically be presented the campus map with the location of the coupon's retailer prominently displayed on the map including a logo or possibly a hyper-link.

Students benefit from the partnership and business methods described herein by being presented with an interactive learning environment for various subjects that are not typically taught in a formal sense. A student receives help with real-world experience such as banking, living on and off campus, and participating in social organizations. The student also becomes familiar with local businesses and other corporations and receives discounts and coupons of various merchandise and services. Through the interactive message boards, the student can communicate with other students, even ones at different universities. Thus, the student is made to feel more comfortable and confident in the new environment of college. For the university, students that are more comfortable and confident will more likely be retained as students and will more likely be supporting alumni. And for businesses, they now have the opportunity to advertise using a media that the student is likely to use and have the ability to collect statistics about how the student interacts with the advertisement.

Although the present invention has been described and illustrated in detail, it is clearly understood that the same is by way of illustration and example only and is not to be taken by way of limitation, the spirit and scope of the present invention being limited by the terms of the appended claims and their equivalents.

1. A method for distributing a gateway application to multimedia information directed to a student at an educational institution, the method comprising the steps of:
distributing the gateway application to newly matriculated students;
arranging within the multimedia information respective coupons from a plurality of businesses;
arranging within the multimedia information one or more informational aids for the student; and
providing a graphical user interface as part of the gateway application permitting the student to selectively access the multimedia information.

2. The method of claim 1, wherein the educational institution is a university.

3. The method of claim 1, wherein the one or more information aids relate to transitioning into college life.

4. The method of claim 1, wherein the plurality of businesses are local to the educational institution.

5. The method of claim 1, further comprising the step of:
arranging within the multimedia information a map of the educational institution.

6. The method of claim 5, wherein the map includes a respective indicator corresponding to each of the plurality of businesses.

7. The method of claim 6, wherein the indicator becomes visible when a focus of the graphical user interface is directed to an area of the map related to the corresponding business.

8. The method of claim 1, further comprising the step of:
receiving income from each of the plurality of businesses for including their corresponding indicator included in the multimedia information.

9. The method of claim 1, further comprising step of:
receiving income from each of the plurality of businesses for including their coupons within the multimedia information.

10. The method of claim 1, further comprising the step of:
arranging within the multimedia information respective advertising space for one or more partnering businesses.

11. The method of claim 10, further comprising the step of:
receiving income from each of the partnering businesses for including their respective advertising space within the multimedia information.

12. The method of claim 1, further comprising the steps of:
tracking access of the multimedia information by the student; and
collecting statistics about how the student accesses the multimedia information.

13. The method of claim 12, further comprising the step of:
collecting income from one or more of the plurality of businesses for providing to the one or more of the plurality of businesses at least a portion of the collected statistics.

14. The method of claim 1, further comprising the steps of:
maintaining a website that includes the multimedia information; and
including a web browser as part of the gateway application.

15. The method of claim 14, further comprising the steps of:
building a web page on-the-fly from the multimedia information at the website; and
transmitting the web page to the gateway application.

16. The method of claim 1, further comprising the steps of:
maintaining the plurality of coupons at a website; and
in response to a request from the gateway application, transmitting the coupons to the gateway application.

17. The method of claim 16, further comprising the step of:
revising one or more coupons while maintaining a current version of the gateway application.

18. The method of claim 1, wherein the one or more information aids are created by the educational institution.

19. The method according to claim 1, wherein the gateway application is distributed during a freshman orientation.

20. A method of providing information to a student at an educational institution, comprising the steps of:
receiving first informational content from the educational institution;
receiving respective second informational content from a plurality of businesses;
arranging the first and second informational content into an interactive, multimedia source of information; and
providing, to the student, access to the interactive, multimedia source of information.

21. The method of claim 20, wherein the step of arranging includes the steps of:
organizing the first and second informational content as hierarchically arranged web pages; and
presenting the web pages through a web server operating on a programmable computer.

22. The method of claim 20, further comprising the step of:
supplying the educational institution with a gateway application for distribution to the student, said gateway application configured to access the interactive, multimedia information.

23. The method of claim 22, further comprising the step of:
updating the first informational content without changing the gateway application.

24. The method of claim 22, further comprising the step of:
updating the second informational content without changing the gateway.

25. The method of claim 20, wherein the respective second informational content includes a coupon.

26. The method of claim 20, further comprising the steps of:
tracking access of the interactive, multimedia information by the student; and
collecting statistics about how the student accesses the interactive, multimedia information.

27. A method of providing content from multimedia information to a student using a gateway application distributed by an educational institution to newly matriculated students, the method comprising the steps of:
receiving a request for the content from the gateway application;
selecting the content from among first informational content received from the educational institution and respective second informational content received from a plurality of businesses; and
transmitting the content to the gateway application.

28. The method of claim 27, further comprising the steps of:
tracking access of the content by the student; and
collecting statistics about how the student accesses the content.

29. The method of claim 27, wherein the respective second informational content includes a coupon.

30. A system for providing information to a student at an educational institution, the system comprising:
a first memory storing first informational content from the educational institution;
a second memory storing respective second informational content from a plurality of businesses; and
a programmable computer, in communication with the first and second memory, and configured to:
select interactive, multimedia content from the first and second informational content, and
provide the interactive, multimedia content to a gateway application distributed by an educational institution to newly matriculated students.

31. The system of claim 30, wherein the programmable computer executes a web server to select and provide the interactive, multimedia content.

32. The system of claim 30, wherein the respective second informational content includes a coupon.

33. A computer readable medium bearing instructions for providing content from multimedia information to a student using a gateway application distributed by an educational institution to newly matriculated students, said instructions being arranged to cause one or more processors upon execution thereof to perform the steps of:
arranging within the multimedia information respective coupons from a plurality of businesses;
arranging within the multimedia information one or more informational aids for the student;
receiving a request from the gateway application requesting selective access to content from the multimedia information; and
in response to the request, generating a reply message comprising the content.

34. A computer readable medium bearing instructions for building a central information source for a student using a gateway application distributed by an educational institution to newly matriculated students, said instructions being arranged to cause one or more processors upon execution thereof to perform the steps of:
receiving first informational content from the educational institution;
receiving respective second informational content from a plurality of businesses;
arranging the first and second informational content into an interactive, multimedia source of information; and
providing, to the student, access to the interactive, multimedia source of information.

35. A computer readable medium bearing instructions for providing content from multimedia information to a student using a gateway application distributed by an educational institution to newly matriculated students, said instructions being arranged to cause one or more processors upon execution thereof to perform the steps of:
receiving a request for the content from the gateway application;
selecting the content from among first informational content received from the educational institution and respective second informational content received from a plurality of businesses; and
transmitting the content to the gateway application.
